(19) United States
(12) Patent Application Publication
(10) Pub. No.: US 2017/0186285 A1
(43) Pub. Date: Jun. 29, 2017

(54) REGISTER SYSTEM CONFIGURED TO COMMUNICATE WITH A CONTROL TERMINAL TO ENABLE OR DISABLE USER ATTRIBUTE AUTHENTICATION

(71) Applicant: TOSHIBA TEC KABUSHIKI KAISHA, Tokyo (JP)

(72) Inventor: Tomonari KAKINO, Fuji Shizuoka (JP)

(21) Appl. No.: 15/374,879

(22) Filed: Dec. 9, 2016

(30) Foreign Application Priority Data
Dec. 25, 2015 (JP) 2015-253557

(51) Int. Cl. G07G 1/00; G06Q 20/18

(52) U.S. Cl. CPC G07G 1/0072; G06Q 20/18; G06Q 20/208

(57) ABSTRACT

A register system includes a code reader configured to optically read a product code, a display, and a processor. The processor controls the display to display the confirmation screen when the generation of the confirmation screen is enabled and a product corresponding to a product code read by the code reader is a confirmation-required product, and to not display the confirmation screen when the generation of the confirmation screen is disabled or the product corresponding to the product code read by the code reader is not a confirmation-required product. Further, the processor registers the product corresponding to the product code with confirmation if the confirmation screen is displayed and without confirmation if the confirmation screen is not displayed.

### CROSS-REFERENCE TO RELATED APPLICATION

This application is based upon and claims the benefit of priority from Japanese Patent Application No. 2015-253557, filed Dec. 25, 2015, the entire contents of which are incorporated herein by reference.

### FIELD

Embodiments described herein relate generally to a register system, such as a merchandise sales processing device and a checkout system, that is configured to establish wireless communication with user devices to authenticate attributes of the users, such as age.

### BACKGROUND

A merchandise sales processing device (register) of one type generates an alert to confirm age of a consumer when age-restricted merchandise (alcoholic liquors, cigarettes, or the like) is registered. The merchandise sales processing device generates the alert even when the customer is apparently not under the required age. Generally, the alert is cleared through an operation by a store clerk or a customer. Also, the merchandise sales processing device cannot restart a checkout process unless the alert is cleared. That is, the checkout process is interrupted from the generation of the alert until the clearance of the alert, process efficiency is compromised.

### DESCRIPTION OF THE DRAWINGS

FIG. 1 is a block diagram of a self-checkout system according to a first embodiment.

FIG. 2 is a flow chart illustrating a procedure of processing executed by a processor of an attendant terminal in the self-checkout system.

FIGS. 3 and 4 are a flow chart illustrating a procedure of processing executed by a processor of a self-terminal in the self-checkout system according to a first embodiment.

FIGS. 5 and 6 are a flow chart illustrating a procedure of processing executed by a processor of a self terminal according to a second embodiment.

### DETAILED DESCRIPTION

An embodiment is directed to providing a register that can improve efficiency of a checkout process.

In general, according to an embodiment, a register system includes a code reader configured to optically read a product code, a display, and a processor. The processor controls the display to display the confirmation screen when the generation of the confirmation screen is enabled and a product corresponding to a product code read by the code reader is a confirmation-required product, and to not display the confirmation screen when the generation of the confirmation screen is disabled or the product corresponding to the product code read by the code reader is not a confirmation-required product. Further, the processor registers the product corresponding to the product code with confirmation if the confirmation screen is displayed and without confirmation if the confirmation screen is not displayed.

Hereinafter, embodiments will be described with reference to the drawings. The embodiments describe a self-checkout system with which a customer performs processes such as registration of merchandise to be purchased to payment, and a merchandise sales processing device used in the system, that is, a so-called self checkout terminal.

### First Embodiment

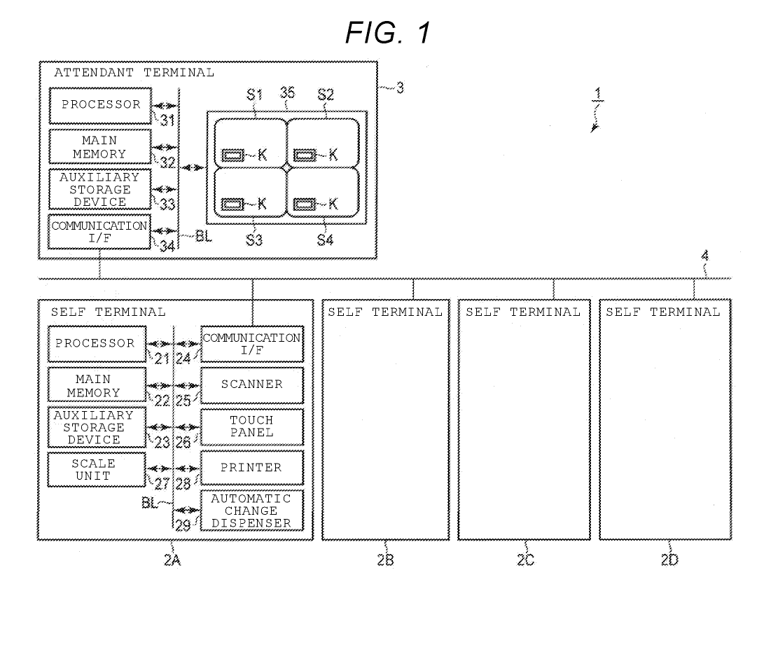

FIG. 1 is a block diagram of a self-checkout system 1 (hereinafter, referred to as a system 1). The system 1 includes four self checkout terminals 2A, 2B, 2C, and 2D (hereinafter, referred to as self terminals 2A, 2B, 2C, and 2D) and one attendant terminal 3. The self terminals 2A, 2B, 2C, and 2D and the attendant terminal (control terminal) 3 are connected to each other through a network 4. The network 4 is typically a local area network (LAN). The network 4 may be a wired network or a wireless network. Although not illustrated, in the network 4, a face-to-face point of sales terminal (POS) and a store server are further connected.

In the present embodiment, the number of self terminals is four. However, this number is not limited to four. The number of self terminals may be two or three, and may be five or more. In addition, the number of the attendant terminal 3 is not limited to one. When the number of the attendant terminal 3 is two, a plurality of self terminals are categorized in two groups, and each attendant terminal may be associated with one of the groups.

Next, a hardware configuration of the self terminals 2A to 2D will be described. Since each of the self terminals 2A to 2D has the same configuration, the self terminal 2A will be described and description of the other self terminals 2B to 2D will be omitted.

The self terminal 2A includes a processor 21, a main memory 22, an auxiliary storage device 23, a communication interface 24, a scanner 25, a touch panel 26, a scale unit 27, a printer 28, and an automatic change dispenser 29, and these elements are electrically connected to each other by a bus line BL. The self terminal 2A connects the processor 21, the main memory 22, and the auxiliary storage device 23 through the bus line BL, and functions as a computer.

The processor 21 is, for example, a central processing unit (CPU) and corresponds to a central part of the computer. The processor 21 controls each element to implement various functions as the self terminal 2A according to an operating system or an application program.

The main memory 22 corresponds to a main storage of the computer. The main memory 22 includes a read only memory (ROM) area and a random access memory (RAM) area. In the ROM area, the operating system and the application program are stored. In the RAM region, data necessary for the processor 21 to execute control are stored.

The auxiliary storage device 23 corresponds to an auxiliary storage of the computer. The auxiliary storage device 23 is, for example, an electric erasable programmable read-only memory (EEPROM), a hard disc drive (HDD), or a solid state drive (SSD).

The communication interface 24 performs data communication with equipments such as the attendant terminal 3 connected through the network 4 according to a communication protocol which is set in advance.

The scanner 25 reads a barcode by optically scanning the barcode. The barcode indicating a merchandise code of merchandise is attached to each piece of merchandise.

The touch panel 26 includes a display device that displays various screens including touch keys, and an input device that receives an input of information allocated to the touch keys upon receiving touch input of each touch key. A checkout screen is displayed on the touch panel 26. A name, the number, and a total amount of the merchandise registered on the self terminal 2A are displayed on the checkout screen. In addition, a touch key for instructing the checkout, so-called a checkout key is displayed on the checkout screen. In addition, a plurality of touch keys to which merchandise with no barcode are allocated may be displayed on the checkout screen. Through operation of these touch keys by an operator, the merchandise code of the merchandise to which no barcode is attached can be input. Here, the scanner 25 and the touch panel 26 function as an input unit that inputs identification information (merchandise code) of the merchandise.

The scale unit 27 measures a weight of the merchandise of which merchandise code is input through the input unit. In a merchandise data file in which a merchandise name, a unit price of merchandise, and the like are preset for each merchandise code, and weight data per one piece of merchandise is set in the merchandise data file. When the merchandise code is input through the input unit, the processor 21 acquires the weight value of the merchandise identified by the merchandise code from the merchandise data file. By comparing a measured value on the scale unit 27 and the weight value from the merchandise data file, the processor 21 confirms validity of the merchandise registration.

The printer 28 prints receipt data indicating details of a commercial transaction on a predetermined receipt sheet.

The automatic change dispenser 29 performs a counting function of counting cash inserted from a slot and a payout function of paying out a change corresponding to change data.

The self terminals 2A to 2D are located along on a self-checkout lane in a store. The self-checkout lane is distinguished from a sales area in which merchandise items are displayed. The customer picks up merchandise (holds the merchandise in a shopping cart or a shopping basket) in the sales area and goes to the self checkout lane. The customer performs processes such as registration of the merchandise and payment by operating the self terminals 2A to 2D. At this time, an attendant clerk stands by near the self checkout lane so as to be able to handle troubles or the like that may occur on the self terminals 2A to 2D. The attendant terminal 3 is located at a standby location of the attendant clerk. Next, the hardware configuration of the attendant terminal 3 will be described.

The attendant terminal 3 includes a processor 31, a main memory 32, an auxiliary storage device 33, a communication interface 34, and a touch panel 35, and these elements are electrically connected to each other by a bus line BL. The attendant terminal 3 connects the processor 31, the main memory 32, and the auxiliary storage device 33 through the bus line BL, and serves as a computer.

The processor 31 is, for example, a central processing unit (CPU) and corresponds to a central part of the computer. The processor 31 controls each element to implement various functions as the attendant terminal 3 according to an operating system or an application program.

The main memory 32 corresponds to a main storage of the computer. The main memory 32 includes a ROM area and a RAM area. In the ROM area, the operating system and the application program are stored. In the RAM region, data necessary for the processor 31 to execute control are stored.

The auxiliary storage device 33 corresponds to an auxiliary storage of the computer. The auxiliary storage device 33 is, for example, the EEPROM, the HDD, or the SSD.

The communication interface 34 performs data communication with equipments such as the self terminals 2A to 2D connected through the network 4 according to a communication protocol which is set in advance.

The touch panel 35 includes a display device that displays various screens including touch keys, and an input device that receives an input of information allocated to a touch key upon receiving touch input of each touch key. A monitoring screen for the attendant is displayed on the display device. The monitoring screen is generated for each of the self terminals 2A to 2D, and is displayed while a screen of the display device is divided. In the present embodiment, since the number of self terminals 2A to 2D is four, four monitoring screens S1, S2, S3, and S4 are displayed in a two-by-two matrix form as illustrated in FIG. 1. Hereinafter, for convenience of explanation, the monitoring screens S1, S2, S3, and S4 are set as screens for the self terminals 2A to 2D, respectively.

Information indicating states of the corresponding self terminals 2A to 2D are displayed on the monitoring screens S1 to S4, respectively. For example, when sales registration of purchasing merchandise is performed on the self terminals 2A to 2D, registration information (a merchandise name, the number, a total amount, and the like) is displayed. In addition, an alert indicating an error that occurred on the self terminals 2A to 2D is also displayed on the monitoring screens S1 to S4. For example, an error is set as having occurred when validity of the merchandise registration cannot be confirmed as a result of collating the measuring data of the scale unit 27 and the weight data acquired from the merchandise data file. At this time, merchandise mismatch alert is displayed on the corresponding monitoring screens S1 to S4.

Images of touch keys K are further displayed on the monitoring screens S1 to S4. If it is detected that the touch key K is touched based on a signal from the input device of the touch panel 35, the processor 31 outputs an operation signal to a self terminal 2m (m: A, B, C, or D) corresponding to a monitoring screen Sn (n: 1, 2, 3, or 4) on which the touch key K is displayed. Here, the touch key K functions as an operation unit. The operation signal is a signal that is generated according to an operation of the operation unit.

The system 1 including the self terminals 2A to 2D and the attendant terminal 3 having the above described configurations operates in a releasing mode and a limitation mode as operation modes function when the purchase of the merchandise to be confirmed which requires confirmation of whether it is permitted to sell the merchandise before selling the merchandise is registered. The system 1 can operate in one of the operation modes. The operation mode can be selected by a user of the system 1. A unit of the system 1 that enables or disables the operation modes is not described here. For example, a well-known option setting function can be utilized. The self terminals 2A to 2D and the attendant terminal 3 may store information related to the operation mode which is enabled, in the auxiliary storage devices 23 and 33, respectively.

In the present embodiment, the merchandise which restricts purchasable age of the customer (purchaser), for example, alcoholic liquors, cigarettes, or the like is set as confirmation-required merchandise before selling. Regarding the confirmation-required merchandise, information indicating the confirmation of age is allocated thereto in association with the merchandise code.

When the age-restricted merchandise is set as the confirmation-required merchandise in the system 1 that operates in the releasing mode, the self terminals 2A to 2D are as a default set to display a screen with which the age of the customer can be confirmed when the purchase of the confirmation-required merchandise is registered, that is, displaying so-called an age confirmation screen. In addition, the touch key K is displayed on the monitoring screens S1 to S4 as deactivation keys. When receiving the operation signal of the touch key (deactivation key) K, the self terminals 2A to 2D deactivate the default setting. That is, the self terminals 2A to 2D do not display the age confirmation screen when the purchase of the confirmation—required merchandise is registered.

On the other hand, in the system 1 that operates in the limitation mode, the self terminals 2A to 2D as a default do not confirm the age of the customer when the purchase of the confirmation-required merchandise is registered. In addition, the touch key K is displayed on the monitoring screens S1 to S4 as activation key. When receiving the operation signal of the touch key (activation key) K, the self terminals 2A to 2D cancel the default setting. That is, the self terminals 2A to 2D display the age confirmation screen when the confirmation-required merchandise is registered.

A layout of the age confirmation screen is not particularly limited thereto. For example, the age confirmation screen may be a screen in which a touch key for the operator (customer or store clerk) to reply “YES” or “NO” to an inquiry that “are you a minor?” is disposed.

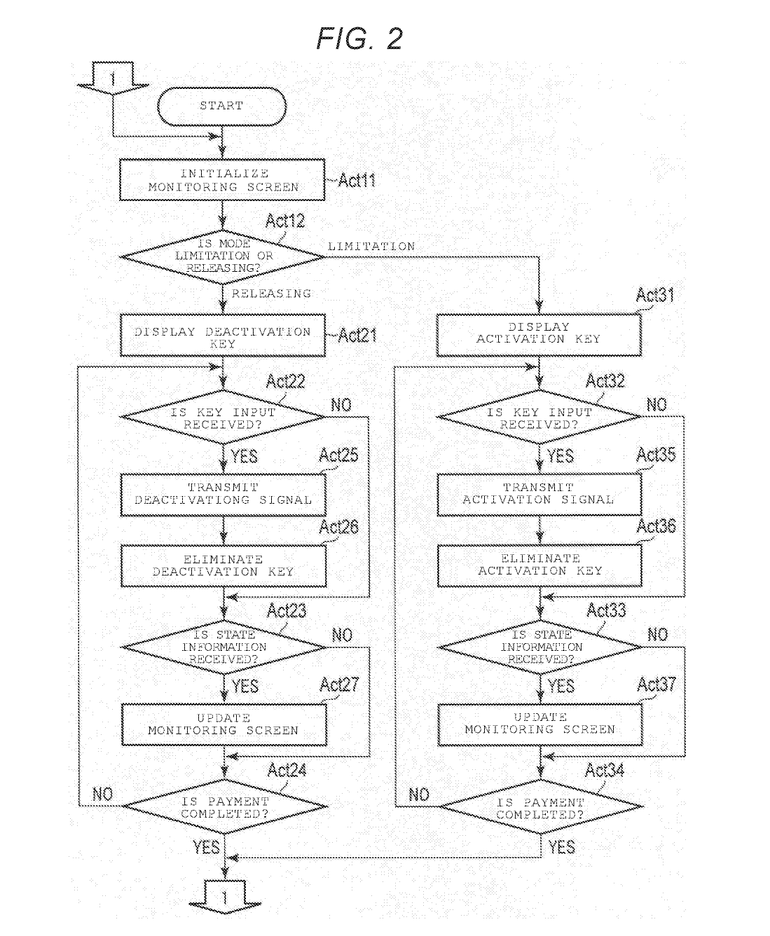

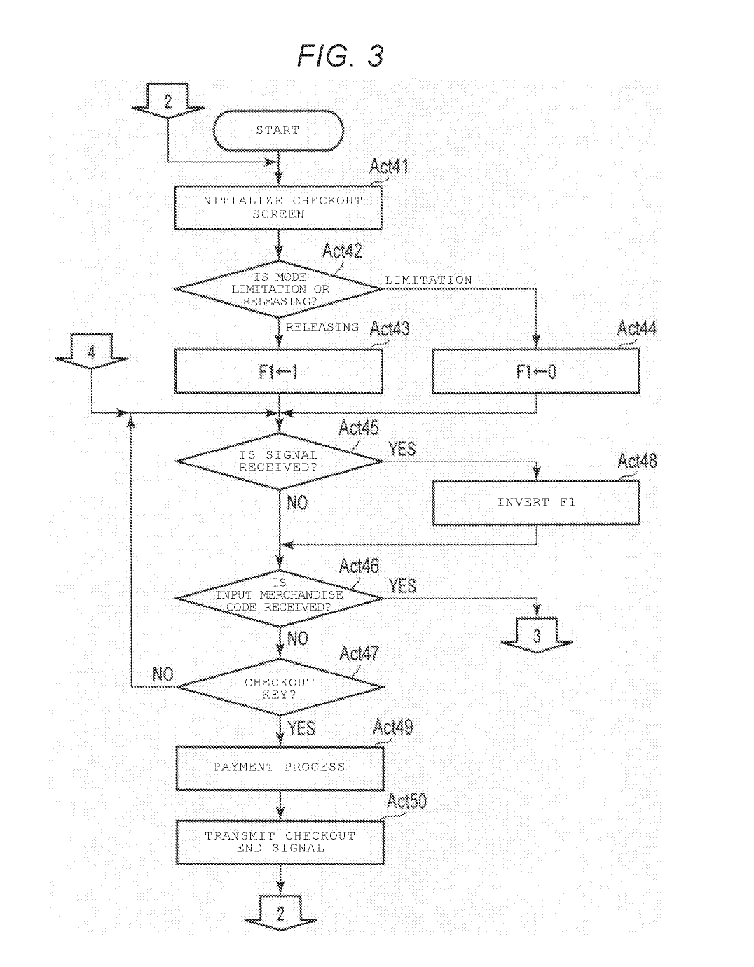

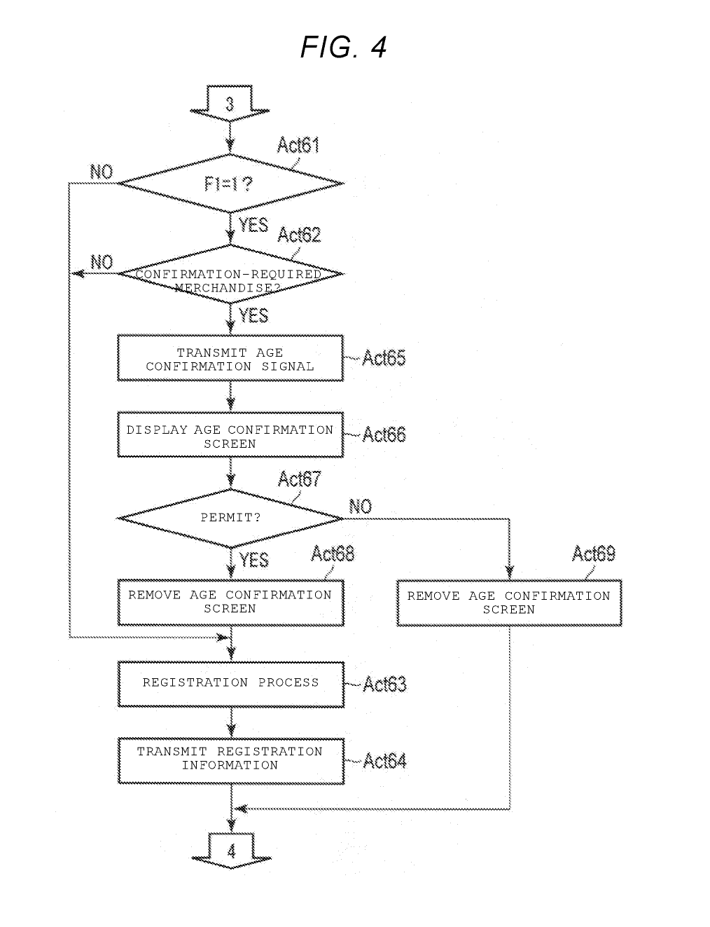

FIG. 2 is a flow chart illustrating a procedure of processing executed by the processor 31 of the attendant terminal 3 according to a program. FIGS. 3 and 4 are flowcharts illustrating a procedure of processing executed by the processor 21 of the self terminals 2A to 2D according to a program. Specifically, the procedure of the processing related to the display control of the monitoring screen S1 corresponding to the self terminal 2A is illustrated in FIG. 2. The procedure of the processing related to registration and payment of merchandise which are executed on the self terminal 2A is illustrated in FIGS. 3 and 4. Hereinafter, referring to FIGS. 2 to 4, an operation of the processor 31 in the attendant terminal 3 and an operation of the processor 21 in the self terminal 2A will be described. A procedure of processing related to the display controls of the monitoring screens S1, S2, and S3 corresponding to the other self terminals 2B, 2C, and 2D, and a procedure of processing related to registration and payment of purchasing merchandise which are executed in the self terminals 2B, 2C, and 2D are similar procedures. For that reason, description thereon will be omitted.

First, the operation of the processor 31 in the attendant terminal 3 will be described. When the system 1 is activated, the processor 31 starts processing of the procedure illustrated in the flow chart of FIG. 2. The processing described below and illustrated in FIG. 2 is an example, and various processes which can result in a similar result can be appropriately carried out.

First, the processor 31 initializes the monitoring screen S1 in Act11. Next, the processor 31 determines an operation mode in Act12. When the operation mode is the releasing mode (“releasing” in Act12), the processor 31 displays a deactivation key K on the monitoring screen S1 in Act21. The processor 31 determines whether or not the deactivation key K is input in Act22. When the deactivation key K is not input (NO in Act22), the processor 31 determines whether or not information indicating a state, so-called state information, is received from the self terminal 2A in Act23. When the state information is not received (NO in Act23), the processor 31 determines whether or not a checkout end signal is received from the self terminal 2A in Act24. When the checkout end signal is not received (NO in Act24), the process returns to Act22. Here, the processor 31 waits until the deactivation key K is input, the state information is received, or the checkout end signal is received in Act22 to Act24.

In the waiting states in Act22 to Act24, when it is detected that the deactivation key K is input (YES in Act22), the processor 31 transmits a deactivation signal to the self terminal 2A in Act25. That is, the processor 31 outputs a signal that gives a deactivation instruction to the self terminal 2A using a communication address set to the self terminal 2A as a transmitting destination. In addition, the processor 31 removes the deactivation key K from the monitoring screen S1 in Act26. Thereafter, the processor 31 turns into the waiting state in Act22 to Act24. Since the deactivation key K is removed at this point in time, determination made in Act22 is “NO”. Accordingly, the processor 31 waits until the state information is received in Act23 or the checkout end signal is received in Act24.

In the waiting states in Act22 to Act24, when the state information is received from the self terminal 2A (YES in Act23), the processor 31 updates the monitoring screen S1 based on the state information in Act27. Thereafter, the processor 31 turns into the waiting state in Act22 to Act24.

In the waiting state in Act22 to Act24, when the checkout end signal is received from the self terminal 2A (YES in Act24), the process returns to Act11. That is, the processor 31 initializes the monitoring screen S1.

On the other hand, when the operation mode is the limitation mode (“limitation” in Act12), the processor 31 displays an activation key K on the monitoring screen S1 in Act31. The processor 31 determines whether or not the activation key K is input in Act32. When the activation key K is not input (NO in Act32), the processor 31 determines whether the state information is received from the self terminal 2A in Act33. When the state information is not received (NO in Act33), the processor 31 determines whether or not the checkout end signal is received from the self terminal 2A in Act34. When the checkout end signal is not received (NO in Act34), the process returns to Act32. Here, the processor 31 waits until the activation key K is input, the state information is received, or the checkout end signal is received in Act32 to Act34.

In the waiting state in Act32 to Act34, when it is detected that the activation key K is input (YES in Act32), the processor 31 transmits an activation signal to the self terminal 2A in Act35. That is, the processor 31 outputs a signal that gives a activation instruction to the self terminal 2A using the communication address set to the self terminal 2A as a transmitting destination. In addition, the processor 31 removes the activation key K from the monitoring screen S1 in Act36. Thereafter, the processor 31 turns into the waiting state in Act32 to Act34. Since the activation key K is removed at this point in time, the determination made in Act32 is “NO”. Accordingly, the processor 31 waits until the state information is received in Act33 or the checkout end signal is received in Act34.

In the waiting state in Act32 to Act34, when the state information is received from the self terminal 2A (YES in Act33), the processor 31 updates the monitoring screen S1 based on the state information in Act37. Thereafter, the processor 31 turns into the waiting state in Act32 to Act34.

In the waiting state in Act32 to Act34, when the checkout end signal is received from the self terminal 2A (YES in Act34), the process returns to Act11. That is, the processor 31 initializes the monitoring screen S1.

Next, the operation of the processor 21 in the self terminal 2A will be described. When the system 1 is activated, the processor 21 starts processing illustrated in the flow charts of FIGS. 3 and 4. The processing described below and illustrated in FIGS. 3 and 4 is an example, and various processes which can result in a similar result can be appropriately carried out.

First, the processor 21 initializes a checkout screen in Act41. Next, the processor 31 determines the operation mode in Act42. When the operation mode is the releasing mode (“releasing” in Act42), the processor 31 sets a first flag F1 to “1” in Act43. When the operation mode is the limitation mode (“limitation” in Act42), the processor 31 sets the first flag F1 to “0” in Act44. The first flag F1 is 1 bit data stored in the RAM area of the main memory 22. Here, the processor 21 configures a storage unit in cooperation with the main memory 22.

When the process of Act43 or Act44 is completed, the processor 21 determines whether or not the deactivation signal or the activation signal is received from the attendant terminal 3 in Act45. When the deactivation signal or the activation signal is not received (NO in Act45), the processor 21 determines whether or not the merchandise code is input in Act46. When the merchandise code is not input (NO in Act46), the processor 21 determines whether or not the checkout key is touched and operated in Act47. When the checkout key is not touched and operated (NO in Act47), the process returns to Act45. Here, the processor 21 waits until the deactivation signal or the activation signal is received, the merchandise code is input, or the checkout key is touched and operated in Act45 to Act47.

In the waiting state in Act45 to Act47, when the deactivation signal or the activation signal is received (YES in Act45), the processor 21 inverts the first flag F1 in Act48. That is, in the system 1 in which the releasing mode is enabled, if the deactivation key K of the monitoring screen S1 is touched and operated in the attendant terminal 3, the deactivation signal is transmitted from the attendant terminal 3 to the self terminal 2A. When the deactivation signal is received, the processor 21 inverts the first flag F1 from “1” to “0”. On the other hand, in the system 1 in which the limitation mode is enabled, if the activation key K of the monitoring screen S1 is touched and operated in the attendant terminal 3, the activation signal is transmitted from the attendant terminal 3 to the self terminal 2A. When the activation signal is received, the processor 21 inverts the first flag F1 from “0” to “1”. Thereafter, the processor 21 returns to the waiting state in Act45 to Act47. Here, the processor 21 serves as a change unit by the process in Act48.

In the waiting state in Act45 to Act47, when the merchandise code is input through the input unit described above (YES in Act46), the process proceeds to Act61 in FIG. 4. That is, the processor 21 checks the first flag F1. When the first flag F1 is set to “1” (YES in Act61), the processor 21 determines whether or not the merchandise identified by the input merchandise code is the confirmation-required merchandise in Act62. The input merchandise code is a merchandise code input through the input unit. Whether or not the merchandise is the confirmation-required merchandise is determined based on the information set to the merchandise data file in association with the input merchandise code. That is, when the information indicating that the merchandise is the confirmation-required merchandise is set, the processor 21 determines that the merchandise is the confirmation-required merchandise. When the information indicating that the merchandise is the confirmation-required merchandise is not set, the processor 21 determines that the merchandise is not the confirmation-required merchandise. Here, the processor 21 serves as a determination unit by the process in Act62.

When the merchandise identified by the input merchandise code is not the confirmation-required merchandise (NO in Act62) or when the first flag F1 is set to “0” (NO in Act61), the processor 21 executes a registration process (sales process) of the purchasing merchandise in Act63. That is, the processor 21 sets the unit price of the merchandise identified by the input merchandise code to a total amount, sets the number of pieces is to “1”, and generates merchandise sales data including the merchandise code, the merchandise name, the unit price, the number of pieces, and the total amount. The processor 21 displays the merchandise name, the number of pieces, and the total amount on the checkout screen, and registers the merchandise sales data to a transaction memory. The transaction memory is formed in the RAM area of the main memory 32. When the registration process of the purchasing merchandise is completed, the processor 21 transmits the registration information to the attendant terminal 3 in Act64. The registration information includes the merchandise name of the merchandise sales data, the number of pieces, and the total amount. Thereafter, the processor 21 returns to the waiting state in Act45 to Act47.

On the other hand, when the merchandise identified by the input merchandise code is the confirmation-required merchandise (YES in Act62), the processor 21 transmits an age confirmation signal to the attendant terminal 3 in Act65. That is, the processor 21 outputs a signal that gives an instruction to issue an alert of the age confirmation to the attendant terminal 3 using the communication address set to the attendant terminal 3 as a transmitting destination. In addition, the processor 21 displays the age confirmation screen on the touch panel 26 in Act66. The processor 21 determines whether to permit to sell in Act67.

When the age confirmation signal is received, the processor 31 of the attendant terminal 3 determines “YES” in Act23. The processor 31 displays an alert indicating that the purchase of the age-restricted merchandise is registered, on the monitoring screen S1 in Act27.

For example, in response to an inquiry “are you a minor?”, the customer who confirms the age confirmation screen operates a touch key of “YES” if he/she is a minor and operates a touch key of “NO” if he/she is an adult. Alternatively, the attendant (store clerk) who notices the alert goes to the installation location of the self terminal 2A and confirms the age of the customer. When the customer is a minor, the attendant operates the touch key of “YES”. When the customer is the adult, the attendant operates the touch key of “NO”.

When it is confirmed that the touch key of “NO” is operated, the processor 21 recognizes that the merchandise is permitted to sell, and when it is confirmed that the touch key of “YES” is operated, the processor 21 recognizes that the merchandise is not permitted to sell. When the merchandise is permitted to sell (YES in Act67), the processor 21 removes the age confirmation screen in Act68. Thereafter, the processor 21 executes Act63 and Act64 described above. That is, the processor 21 performs the registration process (sales process) of the age-restricted merchandise and a transmission process of transmitting the registration information to the attendant terminal 3. Thereafter, the processor 21 returns to the waiting state in Act45 to Act47. When the merchandise is not permitted to sell (NO in Act67), the processor 21 removes the age confirmation screen in Act69. The processes in Act63 and Act64 described above are not executed. Thereafter, the processor 21 returns to the waiting state in Act45 to Act47. Here, the processor 21 serves as the control unit by the processes in Act61 to Act69.

In the waiting state in Act45 to Act47, when it is detected that the checkout key is touched (YES in Act47), the processor 21 executes the payment process in Act49. The payment process is a process for controlling payment for the purchasing merchandise using cash, an electronic money, a credit card, or the like. Since such a payment process is a well-known process, details thereof will be omitted. When the payment process is completed, the processor 21 transmits the checkout end signal to the attendant terminal 3 in Act50. Thereafter, the process returns to Act41, and the processor 21 initializes the checkout screen.

In the system 1 having the self terminals 2A to 2D and the attendant terminal 3 that have the processors 21 and 31 that operate as described above, respectively, the following effect can be achieved.

When the releasing mode is set as the operation mode, the self terminals 2A to 2D basically display the age confirmation screen when the purchase of the confirmation-required merchandise is registered. However, when the deactivation key K which is displayed on the corresponding monitoring screens S1 to S4 is touched and operated, the attendant terminal 3 does not display the age confirmation screen in registering the purchase of the confirmation-required merchandise until payment is completed in the corresponding self terminals 2A to 2D.

The store clerk who is the attendant touches the deactivation key K of the monitoring screen S1, when the customer who performs checkout using the self terminal 2A is not obviously a minor, for example. According to this configuration, since the age confirmation screen is not displayed even if the customer registers the purchase of the confirmation-required merchandise, the process efficiency of the self terminal can be improved.

On the other hand, when the limitation mode is set as the operation mode, the self terminals 2A to 2D basically do not display the age confirmation screen when the purchase of the confirmation-required merchandise is registered. However, when the activation key K which is displayed on the corresponding monitoring screens S1 to S4 is touched and operated, the attendant terminal 3 displays the age confirmation screen in registering the purchase of the confirmation-required merchandise until the payment is completed in the corresponding self terminals 2A to 2D.

The store clerk who is the attendant touches and operates the activation key K of the monitoring screen S1, when the customer who performs accounting using the self terminal 2A is obviously a minor and is not with another adult, for example. According to this configuration, since the age confirmation screen is displayed when the customer registers the purchase of the confirmation-required merchandise, sale of age-restricted merchandise such as alcoholic liquors, cigarettes, or the like can be prevented. In other words, when the customer is obviously an adult, or the customer is a minor and is with another adult, the age confirmation screen is not displayed in registering the purchase of the confirmation-required merchandise. Accordingly, the process efficiency of the self terminal can be improved.

### Second Embodiment

In the first embodiment, in response to registration of the confirmation-required merchandise in a state where the first flag F1 is set to “1”, the age confirmation screen is displayed on the self terminals 2A to 2D. In a second embodiment, the age confirmation screen is displayed in response to operation of the checkout key. The system according to the second embodiment can be obtained by partially modifying the procedure of the information process executed by the processor 21 of the self terminals 2A to 2D. For that reason, the hardware configuration of the system 1 of the first embodiment illustrated in FIG. 1 is employed as it is, and description thereon will be omitted. In addition, since the procedure of the information process executed by the processor 31 of the attendant terminal 3 is the same as that of the first embodiment, the flow chart of FIG. 2 is carried out as it is, and description thereon will be omitted.

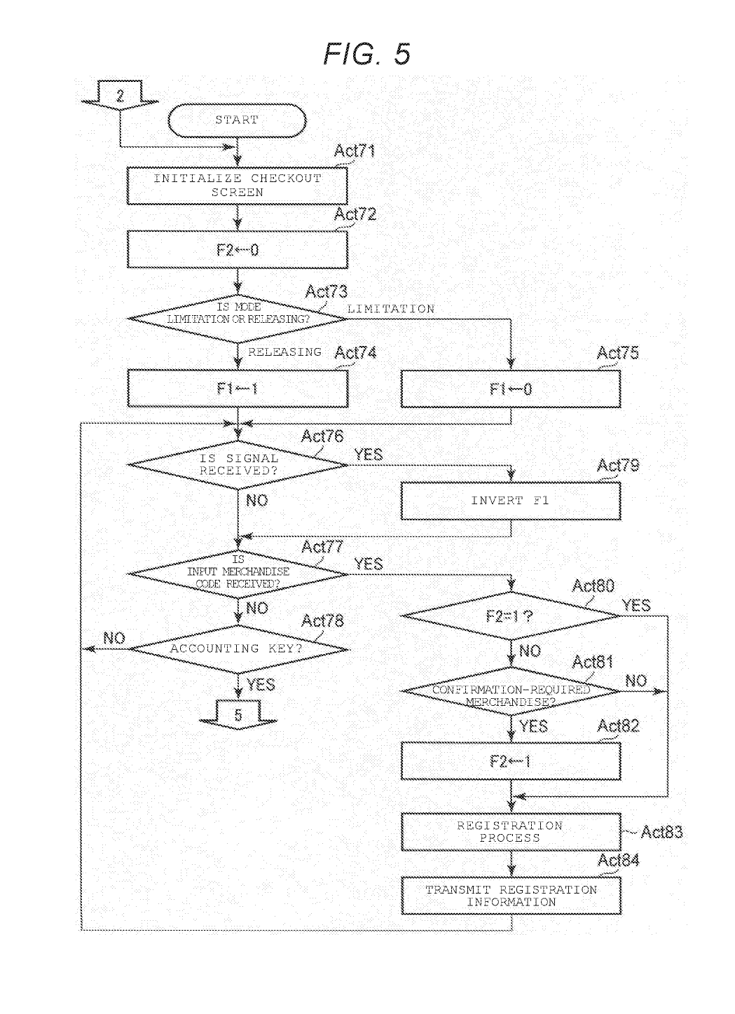

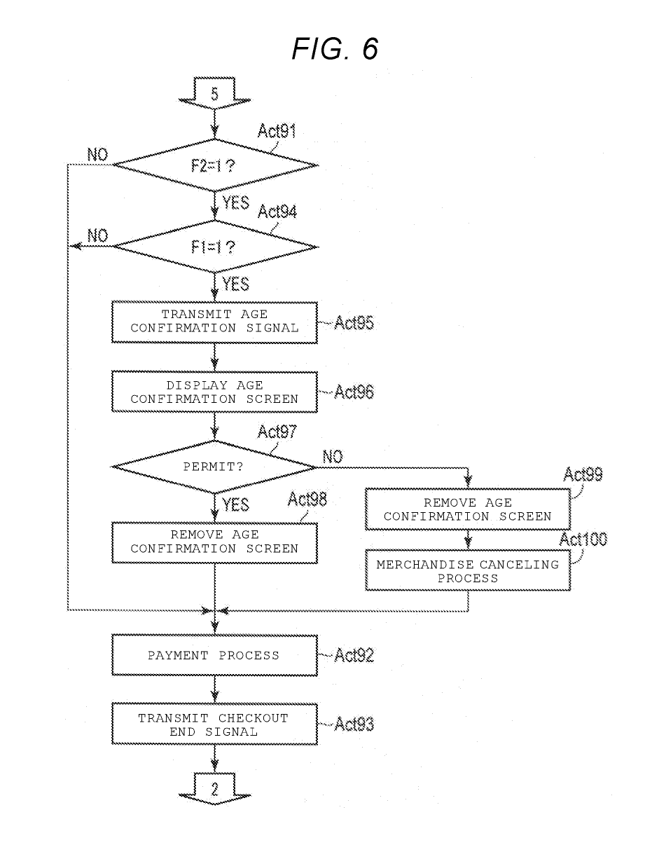

FIGS. 5 and 6 are flow charts illustrating a procedure of processing executed by the processor 21 of the self terminals 2A to 2D according to a program. Specifically, the procedure of processing related to registration and payment of purchasing merchandise which are executed by the self terminal 2A is illustrated in FIGS. 5 and 6. When the system 1 is activated, the processor 21 starts processing of the procedure illustrated in the flow charts of FIGS. 5 and 6. The content of the processes described below and illustrated in FIGS. 5 and 6 are an example, and various processes which can result in a similar result can be appropriately carried out.

First, the processor 21 initializes the checkout screen in Act71. Next, the processor 21 sets a second flag F2 to “0” in Act72. The second flag F2 is 1 bit data stored in the RAM area of the main memory 22. Next, in Act73 to Act79, the processor 31 executes the same processes as those of Act42 and Act48 of the first embodiment. That is, when the releasing mode is set as the operation mode (“releasing” in Act73), the processor 31 sets the first flag F1 to “1” (Act74). When the limitation mode is set as the operation mode (“limitation” in Act74), the processor 31 sets the first flag F1 to “0” (Act75). Thereafter, when the deactivation signal or the activation signal is received (YES in Act76), the processor 21 inverts the first flag F1 (Act79).

On the other hand, when the merchandise code is input through the input unit (YES in Act77), the processor 21 checks the second flag F2 in Act80. When the second flag F2 is set to “0” (YES in Act80), the processor 21 determines whether or not the merchandise identified by the input merchandise code is the confirmation-required merchandise in Act81. When the merchandise is the confirmation-required merchandise (YES in Act81), the processor 21 sets the second flag F2 to “1” in Act82. When the second flag F2 is already set to “1” (YES in Act80) or when the merchandise is not the confirmation-required merchandise (NO in Act81), the processor 21 does not execute the process in Act82.

Thereafter, in Act83 and Act84, the processor 21 executes the same processes as those of Act63 and Act64 of the first embodiment. That is, the processor 21 performs the registration process (sales process) of the merchandise and the transmission process of transmitting the registration information to the attendant terminal 3. Thereafter, the processor 21 returns to the waiting state in Act76 to Act78.

In the waiting state, when it is detected that the checkout key is touched (YES in Act78), the processor 21 checks the second flag F2 in Act91. When the second flag F2 is set to “0”, the confirmation-required merchandise is not included in the purchasing merchandise. In this case (NO in Act91), the processor 21 executes the settlement process in Act92. When the settlement process is completed, the processor 21 transmits the checkout end signal to the attendant terminal 3 in Act93. Thereafter, the process returns to Act71, and the processor 21 initializes the checkout screen.

On the other hand, when the second flag F2 is set to “1”, the confirmation-required merchandise is included in the purchasing merchandises. In this case (YES in Act91), the processor 21 checks the first flag F1 in Act94. When the first flag F1 is set to “0” (NO in Act94), the processor 21 executes Act92 and Act93 described above, and the process returns to Act71. Here, the processor 21 serves as the detecting unit by a process in Act78.

On the other hand, when the first flag F1 is set to “1” (YES in Act94), the processor 21 transmits the age confirmation signal to the attendant terminal 3 in Act95. In addition, the processor 21 displays the age confirmation screen on the touch panel 26 in Act96. The processor 21 determines whether or not to permit to sell in Act97. When the merchandise is permitted to sell (YES in Act97), the processor 21 removes the age confirmation screen in Act98. Thereafter, the processor 21 executes Act92 and Act93 described above, and the process returns to Act71. On the other hand, when the merchandise is not permitted to sell (NO in Act97), the processor 21 removes the age confirmation screen in Act99. In addition, the processor 21 executes a merchandise canceling process in Act100. That is, the processor 21 removes sales data of the confirmation-required merchandise from the transaction memory. Thereafter, the processor 21 executes Act92 and Act93 described above, and the process returns to Act71. Here, the processor 21 serves as the control unit by the processes of Act91 to Act100.

In the second embodiment, when the customer having the confirmation-required merchandise touches the checkout key and when the first flag F1 is set to “1”, the age confirmation screen is displayed. A condition that the first flag F1 is set to “1” is met when the deactivation key is not operated in a state where the releasing mode is set as the operation mode, or when the activation key is operated in a state where the limitation mode is set as the operation mode.

When the releasing mode is set as the operation mode, the store clerk (attendant) touches the deactivation key when the customer who performs checkout using the self terminal 2A is not obviously a minor, for example. According to this configuration, since the age confirmation screen is not displayed even if the customer registers the purchase of the confirmation-required merchandise, the process efficiency of the self terminal 2A can be improved.

On the other hand, when the limitation mode is set as the operation mode, the store clerk touches the activation key when the customer who performs checkout using the self terminal 2A is obviously a minor and the customer is not with another adult, for example. The timing of touching the activation key may be before the customer touches the checkout key. By touching the activation key in this way, the age confirmation screen is displayed before the checkout. Thus, sale of age-restricted merchandise such as alcoholic liquors, cigarettes, or the like to the minors can be prevented. In other words, if the customer is obviously an adult or the customer is a minor and is with another adult, the age confirmation screen is not displayed in registering the purchase of the confirmation-required merchandise. Accordingly, the process efficiency of the self terminal can be improved.

In each of the above embodiments, the device that operates in the limitation mode and the releasing modes as the operation mode is exemplified. However, the device may operate in only one of the operation modes. In addition, the confirmation-required merchandise is not limited to age-restricted merchandise.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A register system comprising:
a code reader configured to optically read a product code;
a display; and
a processor configured to
determine whether or not generation of a confirmation screen is enabled or disabled,
control the display to display the confirmation screen when the generation of the confirmation screen is enabled and a product corresponding to a product code read by the code reader is a confirmation-required product, and to not display the confirmation screen when the generation of the confirmation screen is disabled or the product corresponding to the product code read by the code reader is not a confirmation-required product, and
register the product corresponding to the product code with confirmation if the confirmation screen is displayed and without confirmation if the confirmation screen is not displayed.

2. The register system according to claim 1, further comprising:
a communication interface through which the register system communicates with a control terminal, wherein
the generation of the confirmation screen is enabled or disabled based on a control signal received from the control terminal.

3. The register system according to claim 2, wherein the processor is configured to detect a start and an end of product registration, and to receive the control signal after the start of product registration.

4. The register system according to claim 2, wherein the generation of the confirmation screen is enabled as a default and the control signal received from the control terminal disables the generation of the confirmation screen.

5. The register system according to claim 2, wherein the generation of the confirmation screen is disabled as a default and the control signal received from the control terminal enables the generation of the confirmation screen.

6. The register system according to claim 1, further comprising:
an operation key to conclude product registration, wherein
the confirmation screen is displayed after the operation key is activated.

7. A register system comprising:
a plurality of self-service terminals, each comprising:
a code reader configured to optically read a product code;
a display;
a communication interface; and
a processor configured to
determine whether or not generation of a confirmation screen is enabled or disabled,
control the display to display the confirmation screen when the generation of the confirmation screen is enabled and a product corresponding to a product code read by the code reader is a confirmation-required product, and to not display the confirmation screen when the generation of the confirmation screen is disabled or the product corresponding to the product code read by the code reader is not a confirmation-required product, and
register the product corresponding to the product code with confirmation if the confirmation screen is displayed and without confirmation if the confirmation screen is not displayed; and
a control terminal connected to the communication interface of each of the self-service terminals and configured to transmit a control signal to enable or disable the confirmation screen on each of the self-service terminals.

8. The register system according to claim 7, wherein
in each of the self-service terminals, the processor is configured to detect a start and an end of product registration, and to receive the control signal after the start of product registration.

9. The register system according to claim 7, wherein
in each of the self-service terminals, the generation of the confirmation screen is enabled as a default and the control signal received from the control terminal disables the generation of the confirmation screen.

10. The register system according to claim 7, wherein
in each of the self-service terminals, the generation of the confirmation screen is disabled as a default and the control signal received from the control terminal enables the generation of the confirmation screen.

11. The register system according to claim 7, wherein
each of the self-service terminal includes an operation key to conclude product registration, and
in each of the self-service terminals, the confirmation screen is displayed after the operation key is activated.

12. The register system according to claim 7, wherein
the control terminal includes a display on which a control screen for each of the self-service terminals is displayed, and transmits the control signal to a self-service terminal in response to selection of an activation/deactivation key associated therewith.

13. The register system according to claim 12, wherein
the activation/deactivation key disappears from the control screen upon selection thereof.

14. A method for processing product registration by a register system including a code reader, display, and a processor, comprising:
determining whether or not generation of a confirmation screen is enabled or disabled;
identifying a product based on a product code read by the code reader;
displaying the confirmation screen when the generation of the confirmation screen is enabled and a product corresponding to a product code read by the code reader is a confirmation-required product and not displaying the confirmation screen when the generation of the confirmation screen is disabled or the product corresponding to the product code read by the code reader is not a confirmation-required product; and
registering the product corresponding to the product code with confirmation if the confirmation screen is displayed and without confirmation if the confirmation screen is not displayed.

15. The method according to claim 14, wherein the register system further includes a communication interface through which the register system communicates with a control terminal that supplies a control signal for enabling or disabling of the generation of the confirmation screen.

16. The method according to claim 15, further comprising:
detecting a start and an end of product registration; and
responding to the control signal after the start of product registration.

17. The method according to claim 15, wherein the generation of the confirmation screen is enabled as a default and the control signal received from the control terminal disables the generation of the confirmation screen.

18. The method according to claim 15, wherein the generation of the confirmation screen is disabled as a default and the control signal received from the control terminal enables the generation of the confirmation screen.

19. The method according to claim 14, wherein
the register system further includes an operation key to conclude product registration, and
the confirmation screen is displayed after the operation key is activated.
